(19) United States
(12) Patent Application Publication
(10) Pub. No.: US 2010/0126995 A1
(43) Pub. Date: May 27, 2010

(54) POUR SPOUT FITMENTS

(75) Inventors: Israel Komet, Fallanden (CH); Alain Roulle, Avignon les Saint-Claude (FR)

Correspondence Address: WARN, HOFFMANN, MILLER & LALONE, .P.C, PO BOX 70098, ROCHESTER HILLS, MI, 48307, US

(73) Assignee: Elopak Systems AG, Glattbrugg (CH)

(21) Appl. No.: 12/312,728

(22) PCT Filed: Nov. 26, 2007
(86) PCT No.: PCT/GB2007/004508

§ 371 Date: Jan. 22, 2010

(30) Foreign Application Priority Data
Nov. 25, 2006 (GB) 0623518.8

(51) Int. Cl. B65D 17/40; B65G 51/02

(52) U.S. Cl. 220/276; 406/88

(57) ABSTRACT

A pour spout fitment (2) comprises a tubular spout body (4) insertable between a consumer's lips and for attachment by a flange (6) at an inner end thereof to a container, and a tear element (8) comprising a first portion (10; 32) of substantially flat cross-section throughout and closing the spout body (4) at an outer end of the body (4) and a second portion (12; 44) seizable by a consumer for pulling to tear a loop of weakness (14; 40) extending around the outer end of the spout body (4), the second portion (12; 44) iying beside an annular external surface of the body (4).

This invention relates to a pour spout fitment.

U.S. Pat. No. 5,711,441 discloses a pour spout fitment attached from internally of a carton and having a bottom peripheral flange to be attached to a panel of the carton surrounding a hole in the panel. Above the flange is a spout which converges upwardly and has a cylindrical external locking bead. Above the spout is an outwardly slanted tear band and above the tear band is a reclosure cap having a top, a depending skirt formed with internal interrupted beads and a plug. The tear band is connected to the spout and the cap by thin horizontal tear lines. A finger grip tab extends outwardly and downwardly with respect to the tear band so that the consumer may conveniently grip the tab, pulling it circumferentially around the spout to separate the tab from both the spout and the cap. The cap is dimensioned so that the skirt fits over the outside of the spout, the beads detachably locking under the locking bead. The plug seals against the inside of the spout to prevent spillage.

EP-A-373149 discloses that a sealed carton for containing liquid product such as milk, juice or the like has a one-piece pour spout fitment made of an elastic material, such as polyethylene. The fitment comprises a main body in the form of a pipe or case passed through the wall of the carton and a cover closing an opening of the main body. The cover and the main body are interconnected through a reduced-thickness separable portion which is severed when the cover is opened, and through a reduced-thickness portion which functions as a hinge when the cover is opened. The main body and the cover have formed respectively on and in the outer surfaces thereof an engagement hook and an engagement recess. The hook projects upwardly and rearwardly from a rear part of the cover. When a tab projecting upwardly and forwardly from a front part of the cover is pulled upwardly to open the cover, the distal end of the engagement element engages in the engagement recess so that the cover is maintained in an opened position. When the cover is re-closed, an engaging projection on the upwardly projecting portion of the tab is brought into engagement with the inner surface of the main body, whereby the cover is maintained in the closed position.

EP-A-1279609 discloses a reclosable pour fitment for a carton for a pourable food. The fitment comprises a frame including in turn a peripheral base flange designed to be fitted to the carton at a hole thereof and a very short neck extending upwardly from the base flange and defining a pouring opening; and a lid connected to the frame by a hinge and having a closing portion for engaging the neck and closing the pouring opening, and a pull tab protruding outwards with respect to the neck, located at a pouring side, opposite the hinge, of the fitment and defining a handle to be pulled to raise the lid into an open position. The handle extends downwardly beside a tapered end portion of the frame, that end portion itself extending downwardly beside a front wall of the carton.

U.S. Pat. No. 3,963,140 discloses a reusable bottle cap having a substantially planar top wall portion with an annular depending skirt and a tear tab projecting from the skirt, as well as tear-off indications or preformed score lines comprising two weakening lines extending substantially in line with the edges of the tear tab, across the peripheral skirt of the cap and up to the top wall of the cap, each of the weakening lines being arranged to run therefrom along and slightly spaced from the boundary of the top wall portion of the cap at least for part of the way around the periphery of the top wall portion. This arrangement of the score lines results in elimination of a claw-grip effect, so that the cap can be removed easily after having been torn. It is stated that this effect can be further improved by at least one of the tear-off indications continuing to the peripheral section of the cap on the side of the cap blank opposite the tear tab. This is to prevent the cap from being torn into several parts.

DE-U-202005005442 discloses a pour spout fitment including a tubular pour spout body and a flange whereby the body can be attached to the exterior of a carton. A flexible tongue is connected to the flange at a location on the periphery of the flange and carries a beaded plug sealingly insertable into the mouth of the body such that the bead engages in an undercut below the rim of the mouth. On the opposite side of the body from the flexible tongue is a grip hollow.

According to one aspect of the present invention, there is provided a pour spout fitment comprising a tubular spout body insertable between a consumer's lips and for attachment at an inner end thereof to a container, and a tear element comprising a first portion of substantially flat cross-section throughout and closing said spout body at an outer end of said body and a second portion seizable by a consumer for pulling to tear a loop of weakness extending around said outer end of said spout body, said second portion lying beside an annular external surface of said body.

Owing to this aspect of the invention, it is possible to manufacture simply and cheaply a pour spout fitment from which a consumer can drink conveniently and which is openable by a tearing action by pulling of a tear tab which is so placed as to facilitate handling of the pour spout fitments. In particular, it is possible to prevent the second portion from projecting outwardly to such an extent as might significantly interfere with the relationship between the fitment and an adjacent fitment or piece of equipment.

The loop of weakness may be a closed loop, so that the tear element can be removed completely; this is particularly advantageous if it is intended that the consumer should apply his lips around the spout body in order to be able to drink directly from the container.

The tear element may be in the form of a tear strip which may be profiled so that the first portion thereof, which may be circular in shape, is wider than the second portion thereof, which may be of an elongate shape.

The spout body may have its outer end disposed eccentrically relative to its inner end, with much of the spout body being eccentric relative to its inner end, so as to leave a space in which the tear element extends. This has the advantage of enabling the fitment to be handled as if it were a conventional fitment in which the whole of the spout body is co-axial; in fact, the tear element is preferably so arranged as to extend just inside the volume which would be occupied by a corresponding fitment having its spout body wholly coaxial.

With the second portion of the tear element arranged according to the first aspect of the invention, that second portion may be utilised in orientating the fitment during its transport to the container.

According to a second aspect of the present invention, there is provided, in a method of transporting a pour spout fitment to a container, utilising an opening element of said fitment in orientating said fitment.

Owing to this aspect of the invention, orientation of the fitment can be simplified, since the fitment does not need any additional element for use in its orientation, nor is complex equipment required to produce the desired orientation.

The fitment is advantageously of such shape that it may be advanced using an air jet stream.

In order that the invention may be clearly and completely disclosed, reference will now be made, by way of example, to the accompanying drawings, in which:—

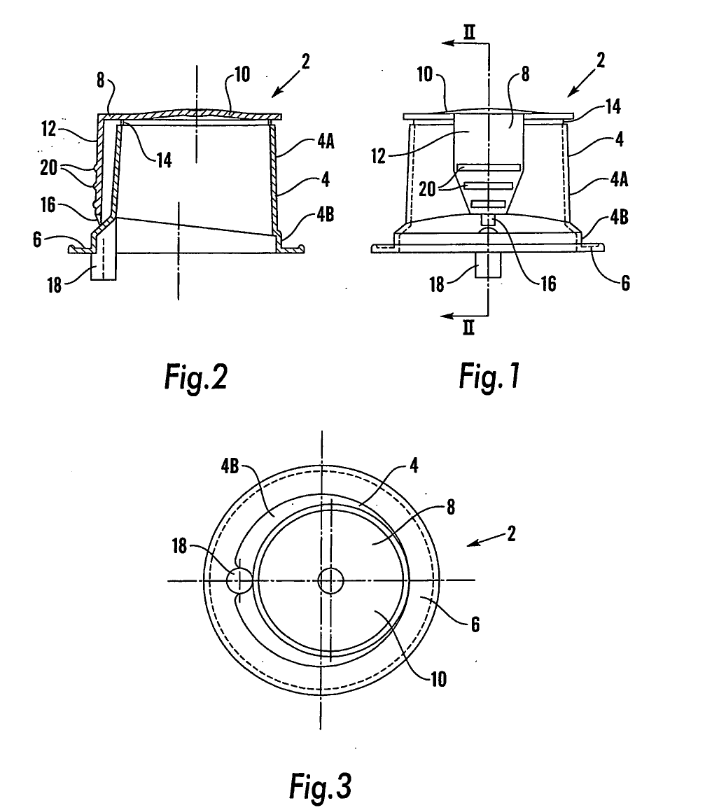

FIG. 1 is a front elevation of a pour spout fitment to be attached to a liquid packaging carton,

FIG. 2 shows a diametral, axial section taken on the line II-II of FIG. 1,

FIG. 3 is an underneath plan view of the fitment,

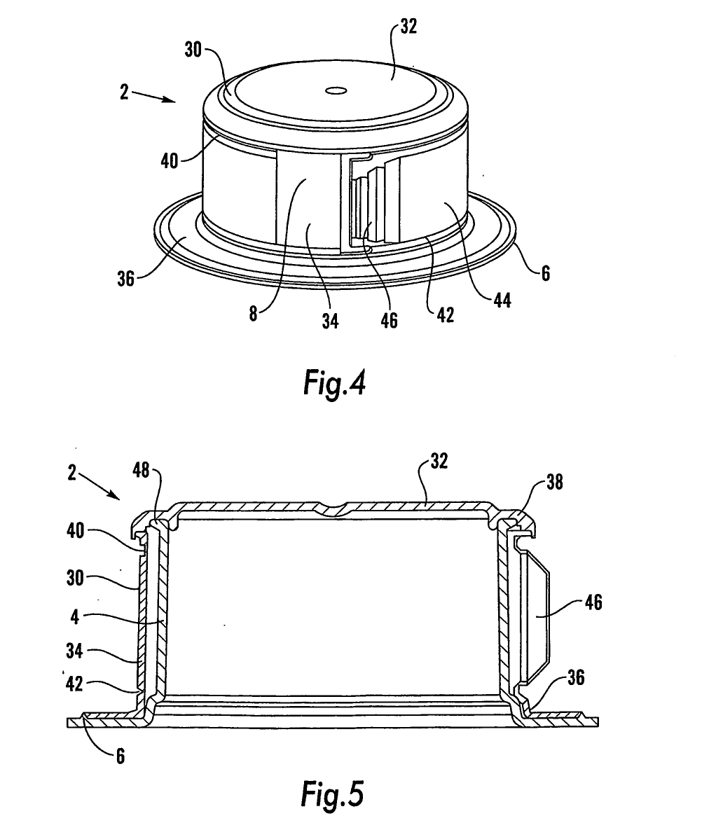

FIG. 4 is a perspective view from above of a modified version of the fitment, and

FIG. 5 shows an axial section through the modified version.

Referring to the drawing, the fitment 2 has been moulded in one piece from thermoplastics. It includes a tubular spout body 4 of slightly and generally frusto-conical form narrowing outwardly. It also includes, at the inner end of the body 4, an external, annular flange 6 whereby the fitment 2 may be ultrasonically sealed to the internal surface of a laminate wall of the carton, after the fitment has been introduced into a hole through that wall from the inside of the carton. For short shelf life of a product, such as fresh milk, the laminate may consist simply of a paperboard substrate with moisture barrier thermoplastics coatings on respective opposite sides thereof. For longer shelflife, the laminate may include, between the paperboard substrate and the inner coating of moisture barrier thermoplastics, an oxygen barrier layer, for example aluminium or ethylene vinyl alcohol. The fitment 2 also includes a tear element in the form of a tear strip 8 which is generally substantially flat in cross-section and which consists of a disc-like portion 10 closing the outer end of the body 4, and an elongate tab-form portion 12 extending initially laterally from the portion 10 and then longitudinally of the body 4, so as to extend beside the body 4 to short of the flange 6. The portion 10 is connected to the body 4 by way of an annular, frangible web 14, whilst the portion 12 may be attached to the body 4 at the lower end of the portion 12 by way of a frangible bridge 16. The fitment 2 as illustrated also includes a peg 18 to be employed in orientating the fitment 2 during its transporting to the carton. However, if possible, it is advisable to omit that peg 18 and instead to use the portion 12 for the purpose of orientation of the fitment 2.

The upper, major part 4A of the body 4 is disposed eccentrically relative to the lower part 4B thereof, whilst the outer end of the body 4 is of smaller diameter than the inner end thereof. Thus, there is left a space which is occupied by the portion 12 in such a manner that it is disposed just at the inside of a volume which would be defined by a frusto-conical spout body co-axial with the flange 6. In this way, the fitment 2 shown can be more readily handled by fitment-transporting and-applying equipment used for pour spout fitments having frusto-conical spout bodies of the latter character. That part of the portion 12 nearer the inner end of the body 4 is formed with unevennesses 20 facilitating gripping of the portion 12 by the consumer.

Instead of the fitment 2 being inserted into a hole through the carton wall from the inside of the container, it is possible to apply the fitment to the external surface of the wall, around an existing hole through the container wall.

In order to open a purchased carton, a consumer seizes the portion 12, pulls it away from the body 4 to break the bridge 16, and then, with his thumb and forefinger gripping the portion 12 between them, he pulls that portion diametrically across the body 4 in a per se conventional peeling action, to break the web 14 and thus detach the strip 8 completely from the body 4. He can then drink from the carton after applying his lips around the body 4.

The version shown in FIGS. 4 and 5 differs significantly from that shown in FIGS. 1 to 3, particularly in that it is designed not only to remain simple and cheap and to allow a consumer to place his lips around the external peripheral surface of the spout body 4 to drink therefrom, but also to protect that external surface against contamination. The fitment of FIGS. 4 and 5 is moulded in two parts, one consisting of the spout body 4 and the flange 6 and the other being a cover 30 of top-hat shape. The cover 30 includes a disc-like portion 32, a skirt 34 extending downwardly therefrom, and an external, annular flange 36 at the lower end of the skirt 34. The disc 32 and the skirt 34 merge into each other by way of an annular channel-form part 38. The skirt 34 has upper and lower loops of weakness 40 and 42 formed therein, the upper loop being an open loop and the lower loop being a closed loop. There is thereby formed a tear strip 44 extending round the external surface of the body 4 and this tear strip has, in one end region thereof, an ear 46 seizable by a consumer. The items 32, 38, 44 and 46 can be considered to constitute a tear element 8. At the upper end of the spout body 4 its rim is in the form of an outwardly protruding bead 48. After the two parts have been moulded, then, at a convenient stage, the cover 30 is placed over the other part 46, the channel 38 is caused to embrace the bead 48 in a liquid-tight manner and the flange 36 is welded to the flange 6. The convenient stage in question may be immediately at the end of the moulding processes or may be when the flange 6 is sealed, for example ultrasonically, to the carton.

To open the version of FIGS. 4 and 5, the consumer seizes the ear 46 and pulls it to tear along the loops of weakness 40 and 42. Since the loop of weakness 42 is closed, the tear strip 44 is completely detached from the part 4, 6, but, since the loop 40 is open, continued pulling by the consumer displaces the portion 32 from the spout body 4, thereby detaching the channel 38 from the bead 48. The consumer can then drink from the body 4.

1-19. (canceled)

20. A pour spout fitment comprising a tubular spout body insertable between a consumer's lips and for attachment at an inner end thereof to a container, and a tear element comprising a first portion of substantially flat cross-section throughout and closing said spout body at an outer end of said body and a second portion seizable by a consumer for pulling to tear a loop of weakness extending around said outer end of said spout body, said second portion lying beside an annular external surface of said body.

21. A fitment according to claim 20 and moulded as one piece.

22. A fitment according to claim 20, wherein said first portion is connected directly to said body by said loop of weakness.

23. A fitment according to claim 20, wherein said second portion has a length dimension extending away from said outer end towards said inner end.

24. A fitment according to claim 20, wherein said outer end is disposed eccentrically relative to said inner end, with much of said body being eccentric relative to said inner end, so as to leave a space in which said tear element extends.

25. A fitment according to claim 24, wherein said tear element is so arranged as to extend just inside the volume which would be occupied by a corresponding fitment having its spout body wholly coaxial.

26. A fitment according to claim 20, wherein said loop of weakness is a closed loop, so that said tear element can be removed completely from said body.

27. A fitment according to claim 20, wherein said tear element is in the form of a tear strip.

28. A fitment according to claim 27, wherein said tear strip is profiled so that said first portion is wider than said second portion.

29. A fitment according to claim 20, wherein said first portion is circular in shape.

30. A fitment according to claim 20 and moulded as first and second pieces, the first of which comprises said body and the second of which comprises said tear element.

31. A fitment according to claim 20, wherein said second portion has a length dimension extending around said annular external surface of said body.

32. A fitment according to claim 31, and further comprising a second loop of weakness extending around said annular external surface of said body and whereby said tear element is connected to said body at said inner end.

33. A fitment according to claim 32, wherein said first loop of weakness is an open loop and said second loop of weakness is a closed loop.

34. A fitment according to claim 30, wherein said inner end of said body and said first portion are in liquid-tight contact with each other.

35. A fitment according to claim 20 and of such shape that it can be advanced using an air jet stream.

36. In combination, a pour spout fitment according to claim 20, and a liquid packaging carton constituting said container and having said fitment attached thereto by way of said inner end.

37. In a method of transporting a pour spout fitment to a container, utilising an opening element of said fitment in orientating said fitment.

38. A method according to claim 37, wherein said fitment is advanced using an air jet stream.
